(19) United States
(12) Patent Application Publication
(10) Pub. No.: US 2017/0048464 A1
(43) Pub. Date: Feb. 16, 2017

(54) MULTI-LENS CAMERA AND MONITORING SYSTEM

(71) Applicant: VIVOTEK INC., New Taipei City (TW)

(72) Inventors: Li-Shan Shih, New Taipei City (TW); WEN-YUAN LI, New Taipei City (TW)

(21) Appl. No.: 15/196,875

(22) Filed: Jun. 29, 2016

(30) Foreign Application Priority Data
Aug. 14, 2015 (TW) 104126640

(51) Int. Cl. H04N 5/247; H04N 5/225; G06K 9/00; H04N 5/232

(52) U.S. Cl. CPC H04N 5/247; H04N 5/23238; H04N 5/2253; H04N 5/2254; G06K 9/00771

(57) ABSTRACT

A multi-lens camera includes a plurality of lens modules, an actuating mechanism, and a controller. Each of lens modules includes an image sensor and a lens. Each of lenses has a fixed focal length, and at least two fixed focal lengths are different. When the lens modules are driven, each of the lens modules captures a corresponding image with a corresponding field of view and outputs a corresponding image signal. The actuating mechanism is coupled with the lens modules. When the actuating mechanism is driven, the actuating mechanism drives the lens modules to scan in a predetermined scene range. The controller controls and drives the actuating mechanism and the lens modules, and the controller receives, processes, and outputs the corresponding image signals. A monitoring system including the multi-lens camera is also provided.

### CROSS-REFERENCES TO RELATED APPLICATIONS

This non-provisional application claims priority under 35 U.S.C. §119(a) on Patent Application No. 104126640 filed in Taiwan, R.O.C. on 14 Aug. 2015, the entire contents of which are hereby incorporated by reference.

### BACKGROUND

Technical Field

The present disclosure relates to a camera, in particular, relates to a multi-lens camera.

Related Art

Since labor costs increase continuously, in order to obtain comprehensive security guard, more people tend to use the monitoring system for security guard under the situation of limited human resources. Generally, in order to monitor wide range, conventional monitoring system usually comprises many cameras or a wide-angle camera. However, the number of the cameras increases the cost of the monitoring system, and the wide angle camera distorts images. Consequently, the conventional monitoring system does not meet the needs.

### SUMMARY

The present disclosure provides a multi-lens camera to meet the needs of the industries.

In an embodiment, a multi-lens camera comprises a plurality of lens modules, an actuating mechanism, and a controller. Each of lens modules comprises an image sensor and a lens. Each of lenses has a fixed focal length, and at least two fixed focal lengths are different. When the lens modules are driven, each of the lens modules captures a corresponding image with a corresponding field of view and outputs a corresponding image signal. The actuating mechanism is coupled with the lens modules. When the actuating mechanism is driven, the actuating mechanism drives the lens modules to scan in a predetermined scene range. The controller controls and drives the actuating mechanism and the lens modules, and the controller receives, processes, and outputs the corresponding image signals.

According to one embodiment of the multi-lens camera, the view directions of the field of view of the corresponding view images captured by each of the lens modules are different.

According to one embodiment of the multi-lens camera, the controller stitches at least part of corresponding images of one of lens modules into a panorama image corresponding to a panorama area and outputs a panorama image signal corresponding to the panorama area.

According to one embodiment of the multi-lens camera, the controller outputs at least two panorama image signals with different focal length.

According to one embodiment of the multi-lens camera, the controller stitches the corresponding image signals by the way of interpolation or extrapolation according to the focal lengths of the corresponding image signals to obtain the panorama image signal and outputs the panorama image signal.

According to one embodiment of the multi-lens camera, the field of views of two adjacent corresponding images have an overlapping area.

According to one embodiment of the multi-lens camera, the lens modules coupled with the actuating mechanism are arranged in the order of the focal length.

According to one embodiment of the multi-lens camera, at least two of the plurality of the lens modules with different fixed focal lengths face to the same direction, capture the corresponding images respectively and sequentially, and output at least two corresponding image signals.

According to one embodiment of the multi-lens camera, the lens modules coupled with the actuating mechanism are arranged in the order of the focal length, at least two of the plurality of the lens modules with different fixed focal lengths face to the same direction, capture the corresponding view images respectively and sequentially, and output at least two corresponding image signals, and two adjacent corresponding view images have an overlapping area.

The present disclosure provides a monitoring system to meet the needs of the industries. The monitoring system comprises at least one above-mentioned multi-lens camera and a host computer. The controller of the multi-lens camera receives and processes the corresponding image signals and relays the corresponding image signals and then output the corresponding image signals. The host computer receives the corresponding image signals output from the controller.

According to one embodiment of the monitoring system, the view directions of the field of view of the corresponding images captured by each of the lens modules are different.

According to one embodiment of the monitoring system, the host computer stitches at least part of corresponding images of one lens module into a panorama image corresponding to a panorama area, and outputs a panorama image signal corresponding to the panorama area.

According to one embodiment of the monitoring system, the host computer outputs at least two panorama image signals with different focal length.

According to one embodiment of the monitoring system, the host computer stitches the corresponding image signals by the way of interpolation or extrapolation according to the focal lengths of the corresponding image signals to obtain the panorama image signal and outputs the panorama image signal.

According to one embodiment of the monitoring system, the field of views of two adjacent corresponding images have an overlapping area

According to one embodiment of the monitoring system, the lens modules coupled with the actuating mechanism are arranged in the order of the focal length.

According to one embodiment of the monitoring system, at least two of the plurality of the lens modules with different fixed focal length face to the same direction, capture the corresponding images respectively and sequentially, and output at least two corresponding image signals.

### BRIEF DESCRIPTION OF THE DRAWINGS

FIG. 1 illustrates a function block diagram of a multi-lens camera according to an embodiment of the present disclosure.

FIGS. 2A-2B illustrate perspective views of a multi-lens camera according to embodiments of the present disclosure.

FIG. 3 illustrates a schematic diagram of a range of corresponding images with a corresponding field of view captured by a lens.

FIGS. 4A-4B illustrate perspective views of a multi-lens camera according to another embodiment of the present disclosure.

FIGS. 5A-5D illustrate schematic diagrams of arrangement methods of lens modules according to an embodiment of the present disclosure.

FIG. 6 illustrates a function block diagram of a monitoring system according to an embodiment of the present disclosure.

### DETAILED DESCRIPTION

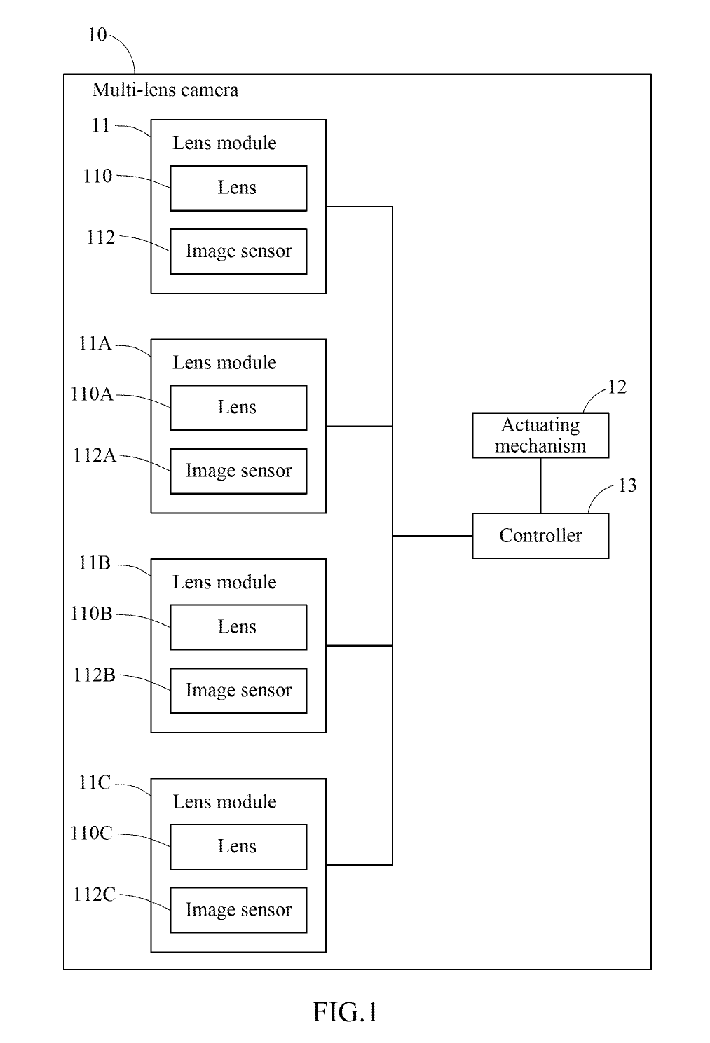

FIG. 1 illustrates a function block diagram of a multi-lens camera according to an embodiment of the present disclosure. The multi-lens camera 10 comprises a plurality of lens modules 11-11C, which are a lens module 11, a lens module 11A, a lens module 11B, and a lens module 11C, in this embodiment.

Each of the lens modules (namely, the lens modules 11-11C) comprises a lens 110 and an image sensor 112. Each lens 110 has a fixed focal length. The lens 110 with the fixed focal length, namely, a prime lens, has the advantages of lighter weight, smaller size, superior optical quality, and most importantly, lower cost of manufacture. Since the prime lens is a fixed-focal-length and the prime lens has fewer lenses than the zoom lens, the problem of chromatic aberration is improved. Most of lens manufacturers produced the prime lenses at the following focal lengths: 2.8 mm (millimeter), 3.6 mm, 4 mm, 6 mm, 8 mm, 12 mm, 16 mm, 25 mm, 35 mm, 50 mm, and 75 mm The fixed focal length of the lens 110 of the present disclosure can be selected from, but not limited to, the above lists.

In this embodiment, the focal length of the lens 110 is 2.8 mm, the focal length of the lens 110A is 8 mm, the focal length of the lens 110B is 25 mm, and the focal length of the lens 110C is 75 mm In other words, the fixed focal lengths of lenses are different so that images captured by the lenses 110, 110A, 110B, 110C represent different depths of field.

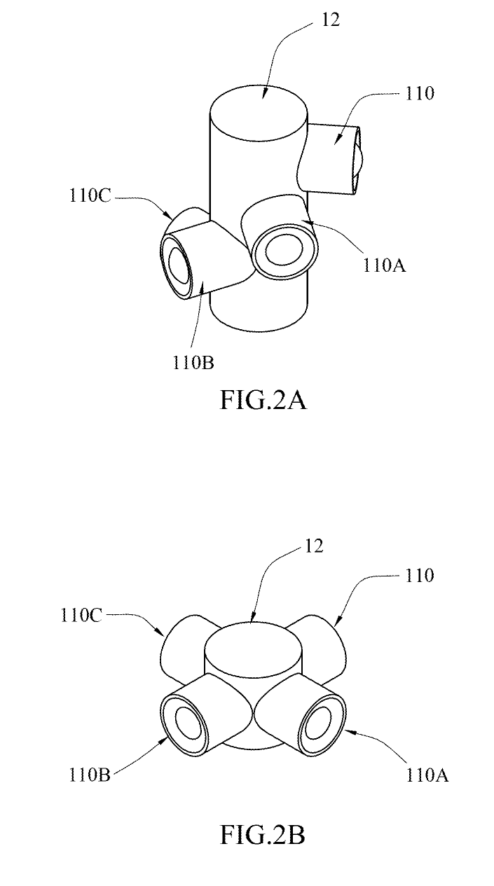

FIG. 2A illustrates perspective views of a multi-lens camera according to an embodiment of the present disclosure. The multi-lens camera 10 comprises an actuating mechanism 12, and the lens modules (namely, the lens modules 11-11C) are coupled with the actuating mechanism 12. When the actuating mechanism is driven, the actuating mechanism drives the lens modules to scan in a predetermined scene range. In this embodiment, the actuating mechanism 12 is columnar and can be driven to rotate. Each of the lenses rotates jointly with the actuating mechanism 12 in 360 degrees, and can be swung within a setting degreed range according to demand. In other embodiments, the actuating mechanism 12 may work in a predetermined scene range by a track.

FIG. 2B illustrates perspective view of a multi-lens camera according to an embodiment of the present disclosure. In this embodiment, the lenses 110, 110A, 110B, and 110C are coupled with the actuating mechanism 12 respectively and face to different directions respectively. The actuating mechanism 12 is short column-shaped. In other embodiment, the actuating mechanism 12 may be disk-shaped or other shape (not shown), for supporting the lenses 110, 110A, 110B, and 110C. It is to be noted that, the shapes of the actuating mechanism 12 are not intended to limit the scope of the present disclosure.

In this embodiment, the lenses 110, 110A, 110B, and 110C are arranged on the same horizontal plane and, at the same time, capture a corresponding image with a corresponding field of view respectively. The corresponding images which are corresponding to each of lenses 110, 110A, 110B, and 110C overlap and are stitched into a panorama image corresponding to a panorama area.

In other words, the predetermined scene range may be a range of 360 degrees or other angle according to demand. The predetermined scene range is the range that the lens can scan or capture within the working range of the actuating mechanism 12. The working of the actuating mechanism 12 can be continuous, or intermittent, according to the needs of user to set. The timing sequence of the working of the actuating mechanism 12 can be adjusted with the view or shot frequency of the lens.

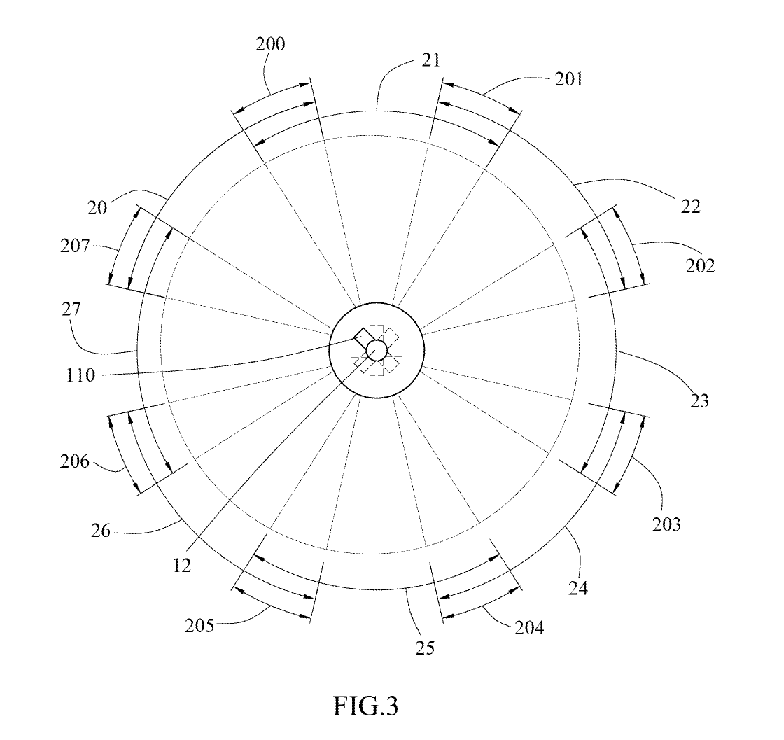

FIG. 3 illustrates a schematic diagram of a range of corresponding images captured by a lens. This embodiment is illustrated by the case of the lens 110. When facing to a first angle, the lens 110 captures the corresponding image 20 and outputs a first corresponding image signal (not shown). When the lens 110 rotates with the actuating mechanism 12 to a second angle, the lens 110 captures the corresponding image 21 and outputs a second corresponding image signal (not shown). When the lens 110 rotates with the actuating mechanism 12 to a third angle, the lens 110 captures the corresponding image 22 and outputs a third corresponding image signal (not shown).

Please refer to FIG. 1 again. The controller 13 of the multi-lens camera 10 is used to control and drive the actuating mechanism 12 and the lens modules 11, 11A, 11B, and 11C. The controller receives, processes and then outputs the corresponding image signals. The controller 13 stores pre-written driver program, which at least comprises a controlling method of the actuating mechanism 12 and the timing sequence of lens modules 11, 11A, 11B, and 11C. The driver program can be pre-written so that the multi-lens can reach the best efficacy. The controller 13 can comprises a memory, which is used to store the corresponding image signals and then output it, or storage it temporarily for being extracted, according to demand

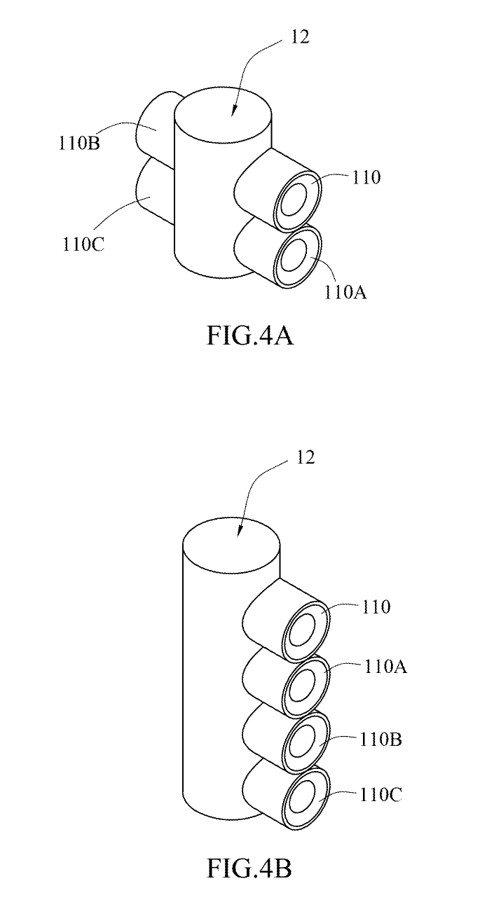

In one embodiment, the view directions of the field of view of the corresponding images captured by each of the lens modules 11-11C are different, shown as FIGS. 2A and 2B. FIGS. 4A-4B illustrate perspective views of a multi-lens camera according to another embodiment of the present disclosure. Please refer to FIG. 4A. One side of the actuating mechanism 12 is coupled with the lenses 110 and 110A, whereas the opposite side of the actuating mechanism 12 is coupled with the lenses 110B, and 110C. The arrangement of the lenses 110, 110A, 110B, and 110C can reduce the high of the actuating mechanism 12 so that the overall volume of the multi-lens camera 10 can be reduced. Please refer to FIG. 4B. All lenses 10, 110A, 110B, and 110C are arranged on the same side of the actuating mechanism 12. The arrangement of the lenses 110, 110A, 110B, and 110C can make all lenses capture the corresponding images at the same time and in the same direction, which facilitates to process the corresponding images in subsequent image processing operation. It is to be noted that, the arrangement of the lenses 110, 110A, 110B, and 110C can be adjusted according to demand, and the arrangements of the lenses are not intended to limit the scope of the present disclosure.

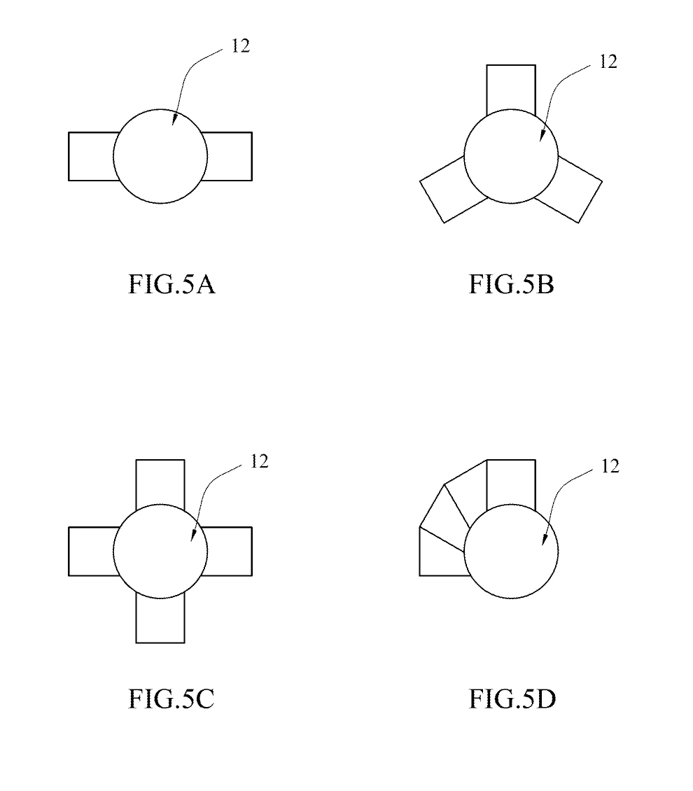

FIGS. 5A-5D illustrate schematic diagrams of arrangement methods of lens modules according to an embodiment of the present disclosure. Please refer to FIGS. 5A and 5B. The amount of the lenses is at least or more than two. In practice, the amount of the lenses is, but not limited to, depending on the demand and the size of the multi-lens camera 10. Please refer to FIGS. 5C and 5D. The lenses can be arranged in different angles (directions). In practice, there are various engagement methods between the lenses and the actuating mechanism 12.

In one embodiment, a single lens module of the multi-lens camera 10 output a corresponding image signal. Please refer to FIG. 3. This embodiment is illustrated by the case of the lens 110. In this embodiment, the lens 110 captures eight corresponding images 20-27, and at least part of corresponding images 20-27 of the lens modules 110 are stitched to form a panorama image corresponding to a panorama area by cutting off the overlapping areas among all corresponding images 20-27. The corresponding images 20-27 outputs correspondingly the first to the eighth corresponding image signals respectively, and the controller 13 stitches the first to the eighth corresponding image signals corresponding to the panorama area and outputs a panorama image signal (not shown). Furthermore, if the multi-lens camera 10 comprises four lens modules, the controller 13 outputs four panorama image signals with different fixed focal length.

As shown in FIG. 3, two adjacent corresponding images have an overlapping area, the corresponding images 20 and the corresponding images 21 have an overlapping area 200, and so on. Thus, eight corresponding images 20-27 have eight overlapping areas 200-207. The controller 13 of the multi-lens camera 10 stitches the corresponding image signals by the way of interpolation and extrapolation according to the focal lengths of the corresponding image signals into the panorama image signal and output the panorama image signal.

In one embodiment, at least two of the plurality of lens modules with different fixed focal lengths face to the same direction and capture the corresponding images respectively and sequentially, and then the lens modules output at least two corresponding image signals. Generally, a user may adjust the zoom lens of a single-lens camera to capture images at different zoom positions. When the zoom lens is zoomed in, the angle of view is narrower, namely, a part of the information of the scene is out of the image. However, in this embodiment, when watching the wider view captured by the lens 110 (focal length is 2.8 mm), the user (such as, a security guard) can easily observe whether any special situation is happening in a wider space. When the security guard finds out the special situation happened and cannot find more detail in the wider view, the security guard can switch to another view captured by the lens 110B (focal length is 25 mm) which face to the same direction as the lens 110A. At the same time, the lens 110A is still working, so the security guard still can observe the situation of the wider space.

In one embodiment, the lens modules coupled with the actuating mechanism 12 are arranged in the order of the focal length. The order of the focal length may be from long focal length to short focal length, or from short focal length to long focal length. Thus, when the multi-lens camera 10 is working, the rotating time or rotating distance of the actuating mechanism 12 can be reduce due to the order of the focal length.

In one embodiment, the lens modules coupled with the actuating mechanism 12 are arranged in the order of the focal length, at least two of the plurality of the lens modules with different fixed focal lengths face to the same direction, capture the corresponding images respectively and sequentially, and output at least two corresponding image signals, and two adjacent corresponding images have an overlapping area.

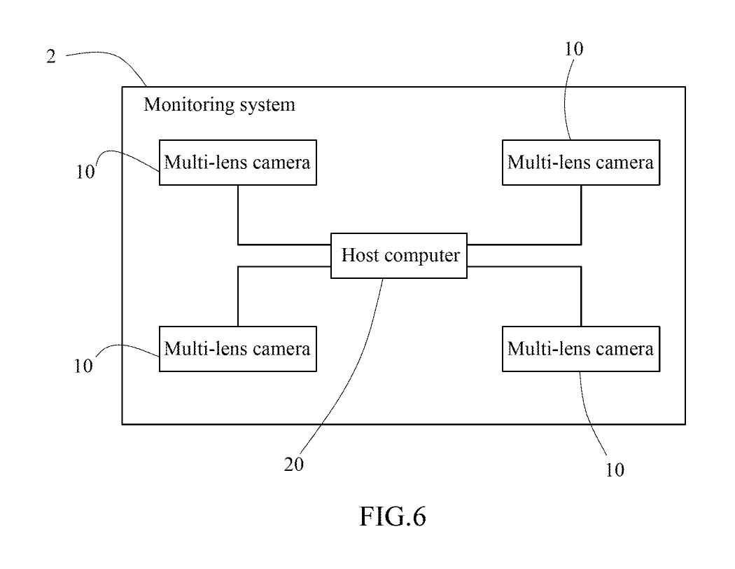

FIG. 6 illustrates a function block diagram of a monitoring system according to an embodiment of the present disclosure. In other embodiment, the other embodiment of the present disclosure provides a monitoring system 2, which comprises a plurality of multi-lens camera 10 and a host computer 20. The amount of the multi-lens camera 10 in monitoring system 2 is set according to the range and the topographic condition of the monitoring space. The multi-lens camera 10 can cooperate with other type camera. The multi-lens camera 10 can be connected to the host computer 20 by wired or wireless communication methods.

In one embodiment, the controller 13 of the multi-lens camera 10 receives and processes the corresponding image signals. Then, the controller 13 relays and outputs the corresponding image signals to the host computer 20. The host computer 20 receives the corresponding image signals from the controller 13.

In one embodiment, in the monitoring system 2, the host computer 20 stitches at least part of corresponding images of one lens module of the multi-lens camera 10 into a panorama image corresponding to a panorama area. The host computer 20 outputs a panorama image signal corresponding to the panorama area. In this embodiment, the subsequent image processing operation is processed by the host computer 20, which facilitates to increase efficiency and decrease the load of the controller 13.

In one embodiment, the host computer 20 of the monitoring system 2 stitches the corresponding image signals by the way of interpolation and extrapolation according to the focal lengths of the corresponding image signals into the panorama image signal and outputs the panorama image signal.

In one embodiment, the lens modules coupled with the actuating mechanism are arranged in the order of the focal length, at least two of the plurality of the lens modules with different fixed focal lengths face to the same direction, capture the corresponding images respectively and sequentially, and output at least two corresponding image signals, and two adjacent corresponding images have an overlapping area.

While the present disclosure has been described by way of example and in terms of the preferred embodiments, it is to be understood that the invention needs not be limited to the disclosed embodiments. For anyone skilled in the art, various modifications and improvements within the spirit of the present disclosure are covered under the scope of the present disclosure. The covered scope of the present disclosure is based on the appended claims.

What is claimed is:

1. A multi-lens camera, comprising:
a plurality of lens modules, wherein each of lens modules comprises an image sensor and a lens, each of the lenses has a fixed focal length, and at least two of the fixed focal lengths are different, when the lens modules are driven, each of the lens modules captures a corresponding image with a corresponding field of view and outputs a corresponding image signal;
an actuating mechanism coupled with the lens modules, wherein when the actuating mechanism is driven, the actuating mechanism drives the lens modules to scan in a predetermined scene range; and
a controller, controlling and driving the actuating mechanism and the lens modules, wherein the controller receives, processes and outputs the corresponding image signals.

2. The multi-lens camera of claim 1, wherein the view directions of the field of view of the corresponding images captured by each of the lens modules are different.

3. The multi-lens camera of claim 1, wherein the controller stitches at least part of corresponding images of one of lens modules into a panorama image corresponding to a panorama area and outputs a panorama image signal corresponding to the panorama area.

4. The multi-lens camera of claim 3, wherein the controller outputs at least two panorama image signals with different focal length.

5. The multi-lens camera of claim 3, wherein the controller stitches the corresponding image signals by the way of interpolation or extrapolation according to the focal lengths of the corresponding image signals to obtain the panorama image signal and outputs the panorama image signal.

6. The multi-lens camera of claim 1, wherein the field of views of two adjacent corresponding images have an overlapping area.

7. The multi-lens camera of claim 1, wherein the lens modules coupled with the actuating mechanism are arranged in the order of the focal length.

8. The multi-lens camera of claim 1, wherein at least two of the plurality of the lens modules with different fixed focal length, face to the same direction, capture the corresponding images respectively and sequentially, and output at least two corresponding image signals.

9. The multi-lens camera of claim 5, wherein the lens modules coupled with the actuating mechanism are arranged in the order of the focal length, at least two of the plurality of the lens modules with different fixed focal lengths face to the same direction, capture the corresponding images respectively and sequentially, and output at least two corresponding image signals, and two adjacent corresponding images have an overlapping area.

10. A monitoring system, comprising:
a multi-lens camera, comprising:
a plurality of lens modules, wherein each of lens module comprises an image sensor and a lens, each lens has a fixed focal length, and at least two fixed focal lengths are different, when the lens modules are driven, each of the lens modules captures a corresponding image with a corresponding field of view and outputs a corresponding image signal;
an actuating mechanism coupled with the lens modules, wherein when the actuating mechanism is driven, the actuating mechanism drives the lens modules to scan in a predetermined scene range; and
a controller, controlling and driving the actuating mechanism and the lens modules, wherein the controller receives and processes the corresponding image signals and relays the corresponding image signals and then output the corresponding image signals; and
a host computer, receiving the corresponding image signals output from the controller.

11. The monitoring system of claim 10, wherein the view directions of the field of view of the corresponding images captured by each of the lens modules are different.

12. The monitoring system of claim 10, wherein the host computer stitches at least part of corresponding images of one lens module into a panorama image corresponding to a panorama area, and outputs a panorama image signal corresponding to the panorama area.

13. The monitoring system of claim 12, wherein the host computer outputs at least two panorama image signals with different focal length.

14. The monitoring system of claim 12, wherein the host computer stitches the corresponding image signals by the way of interpolation or extrapolation according to the focal lengths of the corresponding image signals to obtain the panorama image signal and outputs the panorama image signal.

15. The monitoring system of claim 10, wherein the field of views of two adjacent corresponding images have an overlapping area.

16. The monitoring system of claim 10, wherein the lens modules coupled with the actuating mechanism are arranged in the order of the focal length.

17. The monitoring system of claim 10, wherein at least two of the plurality of the lens modules with different fixed focal length face to the same direction, capture the corresponding images respectively and sequentially, and output at least two corresponding image signals.
